(19) United States
(12) Patent Application Publication
(10) Pub. No.: US 2002/0112744 A1
(43) Pub. Date: Aug. 22, 2002

(54) Method and device for the removal of dirt by means of steam and detergent

(76) Inventor: Gerardus Wilhelmus Maria Besseling, Huizen (NL)

Correspondence Address: Steven L. Permut, REISING, ETHINGTON, BARNES, KISSELLE, LEARMAN & MCCULLOCH, PC, P.O. BOX 4390, Troy, MI, 48099-4390, US

(21) Appl. No.: 10/054,142

(22) Filed: Jan. 22, 2002

Related U.S. Application Data
(63) Continuation of application No. PCT/NL00/00519, filed on Jul. 21, 2000.

(30) Foreign Application Priority Data
Jul. 22, 1999 (NL) 1012675
Aug. 24, 1999 (NL) 1012895

(51) Int. Cl. B08B 7/04

(52) U.S. Cl. 134/30; 134/36; 134/37; 15/345; 15/320

(57) ABSTRACT

In a method and device for the removal of dirt by means of steam and cleaning agent the cleaning agent is injected in a metered way into the steam and atomized, so that the mixture formed is applied in a gaseous state to the dirt to be removed. Such a gaseous mixture has a higher activity than a mixture of steam and droplets of liquid cleaning agent.

### CROSS-REFERENCE TO RELATED APPLICATION

This is a continuation application of PCT/NL00/00519 filed Jul. 21, 2000, which PCT application claims priority of Dutch patent application numbers 1012675 and 1012895 filed Jul. 22, 1999 and Aug. 24, 1999, herein incorporated by reference.

### FIELD OF INVENTION

The present invention relates to a method and device for the removal of dirt from a substrate by means of steam and cleaning agent.

### BACKGROUND OF THE INVENTION

A method known in the art comprises the steps of metering cleaning agent and mixing it with the steam, and bringing the mixture thus formed into contact with the dirt to be removed. Such a method can be used for cleaning floors, floor covering, carpets and clothes, but also for cleaning many kinds of objects, such as greasy and caked equipment in catering kitchens. Walls and ceilings, for example tiled walls, can also be cleaned by means of steam cleaning. A special application relates to the removal of chewing gum residues.

In the case of a device used in practice the steam and the cleaning agent are mixed together in a mixing chamber, which is set up on a mobile frame, and subsequently pumped by way of a common line to an application device, such as a spray gun or spray lance. In view of the range, the connection between the mixing chamber and the application device often consists of a flexible hose with one chamber, which hose can have a length of over 10 meters. Dirt that is difficult to remove is first preheated with steam, after which a mixture of steam and cleaning agent is applied, so that the dirt is actually removed. For the cleaning treatment of the next dirty spot, the cycle of pretreatment with steam and subsequent actual cleaning with a mixture of steam and cleaning agent has to be repeated. On the one hand, this means that after the heating the hose has to be emptied completely before the mixture of steam and cleaning agent reaches the nozzle and, on the other hand, that the relatively long hose, which after the treatment with steam and cleaning agent is still filled with the mixture, first has to be emptied before the next dirty spot can be cleaned. Since each dirty spot, in particular if there is stubborn dirt, has to be treated virtually separately, this cycle of steps takes a relatively great amount of time, and cleaning agent and steam are wasted.

The present invention aims to shorten the cycle time of the method and to improve the general efficiency of the cleaning, in particular the cleaning power of a cleaning agent, and also to reduce the consumption of cleaning agent.

### SUMMARY OF THE INVENTION

The abovementioned objects are achieved according to the invention with a method for the removal of dirt by means of steam and a cleaning agent, which method comprises the steps of supplying cleaning agent and mixing it with the steam, and bringing the mixture into contact with the dirt to be removed, in which the cleaning agent is injected into the steam and is brought into contact in a gaseous state with the dirt to be removed.

It has been found that the cleaning power of a cleaning agent that is used in combination with steam, in particular low-pressure steam, can be improved by injecting the cleaning agent, which is generally used in liquid form as an aqueous solution, into the steam and thus atomizing it, so that, as a result of expansion and heating, the constituents of the cleaning agent are converted into the gaseous state, after which the gaseous mixture thus formed is brought into contact with the dirt. It is assumed that the atomization leads to a highly active form of reaction of the constituents of the cleaning agent, so that these constituents in combination with steam act more rapidly upon the dirt to be removed, so that the total treatment duration can be shortened and the efficiency is improved.

It is pointed out in passing that GB-A-1449483 discloses a steam cleaner in which a cleaning agent can be supplied in a metered way to a mixture of hot water, generated steam and combustion gases at a point halfway along the line between steam generator and application device, in order to permit better regulation of the cleaning process by means of the supplied quantity of cleaning agent. In view of the composition of the mixture at the position of the infeed of the cleaning agent and the position itself, it is not likely that the cleaning agent is injected into the mixture in such a way that atomization occurs and that the mixture thus formed is brought in a gaseous state into contact with the dirt to be removed.

U.S. Pat. No. 4,327,459 discloses a steam cleaner with removal by suction, in the case of which steam and cleaning agent can be supplied by way of separate lines to a mixing chamber of an application device. There is no question of injection of the cleaning agent into the steam here, but the liquid cleaning agent is made to flow out together with the steam into the mixing chamber.

The invention also relates to a device for the removal of dirt by means of steam and cleaning agent, in particular a low-pressure steam cleaner. A device for the removal of dirt by means of steam and cleaning agent, in particular a low-pressure steam cleaner comprises a water supply container, a first pump connected to the water supply container, a steam generator for converting water into steam, having a supply line connected to the first pump and having a discharge line for the discharge of steam, a stock container for cleaning agent, which is connected to a second pump, and an application device which is in communication with the discharge line of the steam generator, and also regulating means for supplying steam or cleaning agent to the application device, wherein the discharge line of the second pump is connected to the discharge line of the steam generator by means of connecting means in such a way that during operation injection of the cleaning agent into the steam occurs and the connecting means and application device are designed in such a way that during operation a gaseous mixture of steam and cleaning agent is delivered by the application device. Such a device generally comprises a frame, preferably a mobile frame, in which a water supply container, a first pump connected to the water supply container, a steam generator for converting water into steam and having a supply line connected to the first pump and a discharge line for the discharge of steam formed, a stock container for cleaning agent, which is connected to a second pump, and an application device which is in communication with the discharge line of the steam generator are set up, generally inside a closed housing, and which device is further provided with regulating means for supplying steam and a cleaning agent respectively to the application device. According to the invention, the discharge line of the second pump is connected to the discharge line of the steam generator by means of connecting means in such a way that during operation injection of the cleaning agent into the steam and atomization occur and the connecting means and application device are designed in such a way that during operation a gaseous mixture of steam and cleaning agent is delivered by the application device.

Such a steam cleaner makes it possible to carry out the method according to the invention and to achieve the envisaged advantages.

### BRIEF DESCRIPTION OF THE DRAWINGS

The method and device according to the invention for the removal of dirt are explained below with reference to the appended drawings, in which:

FIG. 1 shows a diagram illustrating the construction of an embodiment of a device according to the invention; and

FIG. 2 shows a diagrammatic cross section of a preferred embodiment of an application device with injection, atomization and removal by suction.

### DESCRIPTION OF THE PREFERRED EMBODIMENTS

The steam and the cleaning agent in the case of the method according to the invention are advantageously likewise supplied separately to an application device, the injection or atomization of the cleaning agent being carried out in or near the application device. In the case of this preferred embodiment a metered quantity of cleaning agent is atomized in the steam in or close to the application device, so that the highly active form of reaction of the cleaning agent, which appears to be unstable, is still present at the time of emergence from the application device, since the distance travelled, and therefore the period of time between injection and atomization, on the one hand, and emergence, on the other hand, is short. Furthermore, by incorporating suitable shut-off means, such as a one-way valve, into the supply line of the cleaning agent, it is ensured that the long hose does not have to be emptied first before a new cycle can be started or a partial step thereof can be carried out. The consumption of cleaning agent is further reduced and the cleaning time shortened in this way.

In order to prevent liquid droplets of cleaning agent—the less active form—from being present in the steam at the time of emergence from the application device, the cleaning agent can advantageously be preheated prior to the atomization. According to a special embodiment, the cleaning agent is preheated by heat exchange with the steam, which can be carried out, for example, by bringing the individual supply lines into heat-exchanging contact with each other prior to the atomization.

It is preferable to work with superheated steam at a temperature in the region of 120-160° C., in particular 120-140° C., and at low pressure below approximately 10 bar, more preferably 4-7 bar. The low-pressure steam means that only a small quantity of water is required, approximately 50 liters per 200-400 m², so that the cleaned surface is dry virtually immediately. A low-pressure steam cleaner (max. 10 bar) is preferably used for carrying out the cleaning method according to the invention. Such a cleaner produces virtually no noise nuisance, so that it is not necessary for those reasons to close off the area to be cleaned, for example shopping street, floor of the shop or the like. Furthermore, working with low pressure ensures that the substrate or object to be cleaned is not damaged.

In the case of stubborn dirt, such as chewing gum residues, the dirt to be removed is advantageously preheated with steam prior to the gaseous mixture of steam and cleaning agent being brought into contact with the dirt. If necessary, the treated and/or disintegrated dirt can be collected by being sucked up.

The method according to the invention can be used in particular with the cleaning agent, which is an aqueous solution that comprises phosphate compounds, comprising at least a combination of orthophosphate, polyphosphate and pyrophosphate, and also at least an anionic surfactant, a non-polar organic solvent and an emulsifier.

The phosphate compounds consist of a combination of at least orthophosphate PO₄³⁻, polyphosphate P₂O₇⁴⁻ and pyrophosphate P₃O₁₀⁵⁻.

This preferred cleaning agent further contains an anionic surfactant, such surfactants being known per se. A mixture of anionic surfactants and nonionic surfactants can also be used.

Such a cleaning agent also contains a small quantity of organic solvent, which is preferably a petroleum fraction obtained by distillation of crude petroleum. In order to emulsify the non-polar saturated hydrocarbons of the solvent used in the polar water, the cleaning agent further comprises an emulsifier.

When the method according to the invention is used in the case of such a cleaning agent, with the cleaning agent being injected into the steam and atomized and being brought into contact in the gaseous state with the dirt to be removed, it is found that the consumption of cleaning agent is reduced considerably compared with the method according to the prior art, in which steam and cleaning agent are mixed with each other in a mixing chamber.

In the case of that method according to the prior art the ratio of steam to dilute cleaning agent was approximately 4:1, while in the case of the method according to the invention the ratio of steam to dilute cleaning agent can be of the order of 6:1 in order still to achieve efficient removal of dirt. More steam (greater ratio) gives a poorer result, while more cleaning agent hardly gives any better effect.

In the device according to the invention the discharge line of the second pump is advantageously connected to one end of a line for cleaning agent, the other end of which line opens out by way of an aperture with smaller dimensions than the line for cleaning agent into a steam line, which connects the steam generator to the application device. The relatively small aperture at the end of the line for cleaning agent and the second pump ensure that sufficient pressure is built up in the line for cleaning agent, so that during the emergence of the cleaning agent through the relatively small aperture expansion—and consequently gas formation—occurs, which leads to an unstable, highly active form of the cleaning agent. Other connecting means between the line for cleaning agent and the steam line which have the same effect can also be used.

In order to preheat the cleaning agent prior to the injection and atomization, the line for cleaning agent and the steam line are in a heat-exchanging relationship with each other upstream of the aperture.

According to a special preferred embodiment of the device according to the invention, the line for cleaning agent and the steam line are formed by compartments of a flexible hose containing at least two compartments. The compartment through which the steam is conveyed is advantageously provided on the outside of a thicker outside wall, so that heat transfer will occur primarily to the line for cleaning agent. A flexible hose consisting of several compartments can also have a compartment in which connecting lines for the control of the regulating means by operating members are accommodated. Such operating members will preferably be provided in a handle of the application device, such as a spray gun or spray lance.

The application device can be provided with a suction nozzle for sucking up steam and dirt that has been removed, which suction nozzle is in communication with vacuum means by way of a suction line. Such an embodiment is particularly important for indoor use, where the fewest possible traces are left behind on the treated surfaces and subsequent treatments are therefore not necessary. Removal by suction also makes it possible to clean high substrates such as ceilings without the operative having trouble with dripping water containing dirt residues.

Since the steam consumption is very low, the vacuum means preferably comprise a vacuum pump with low flow and high vacuum, by means of which a directed suction is possible without the steam treatment and the suction counteracting each other. In other words, only a small quantity of air is sucked in, which air can very easily absorb the generated steam in the form of water, so that little or no cooling of the substrate and dirt to be treated occurs. The action of the steam upon the substrate and the dirt is consequently improved. This action is improved even further by the use of a pump, which has a high vacuum in addition to a low flow, because a directed suction is obtained in that way. As a result, the steam and the dirt can be removed in a regulated manner, so that the air displacement and accompanying cooling phenomena of the substrate and dirt are limited even further.

The application device advantageously comprises a spray head, a suction nozzle of the suction means being disposed at one side of the spray head. Such an embodiment is advantageous, since the dirt and the substrate are first treated with the steam, which is then sucked away in a directed manner at one side of the spray head, so that the steam treatment and the removal by suction do not interfere with each other.

In order to improve the action of such a steam treatment even further, the end of the spray head advantageously extends beyond the end of the suction nozzle. Since the vacuum pump used sucks in a relatively narrow air column, this arrangement of the suction nozzle relative to the spray head from which the steam emerges to the outside can increase the cleaning action of the steam.

A compressed air line of the vacuum pump is preferably connected to a separating chamber for separating dirt and water, on the one hand, and air, on the other hand. An example of such a separating chamber consists of a vessel in which plates which may be cooled or otherwise are disposed in a vertical manner, with which plates the sucked-in air laden with dirt and water collides, with the result that the dirt falls down and the water condenses. A collection container is preferably provided for the collection of the separated dirt and water, which container is connected to the separating chamber, in general the bottom of said chamber.

The application device may, if desired, be provided with a brush or brush head, which can facilitate the removal of dirt.

The method according to the invention can be used either indoors or outdoors, for example in shopping streets and shopping centres, on platforms and at stops for public transport, in schools, squares, playgrounds, hotels and restaurants, theme parks, sports complexes, stadiums, filling stations, airports and entrances, but it is also suitable for specialist cleaning such as in catering kitchens and other places where hygiene is important. The method can be carried out on any type of substrate, including asphalt, concrete, paving stones, natural stone, carpet, floor covering, doormats etc., and also on tiled walls and the like.

For cleaning large surfaces use can be made of a mobile device, the necessary equipment being set up in the loading area of a van or on a trailer. The operatives can then cover a large area using the long hoses, without having to move the mobile device each time. In general, such a mobile device will be provided with its own electrical power supply.

For cleaning objects inside buildings and the like, use can be made of smaller mobile devices without steam unit, for which the required electrical power is drawn directly from the electricity mains.

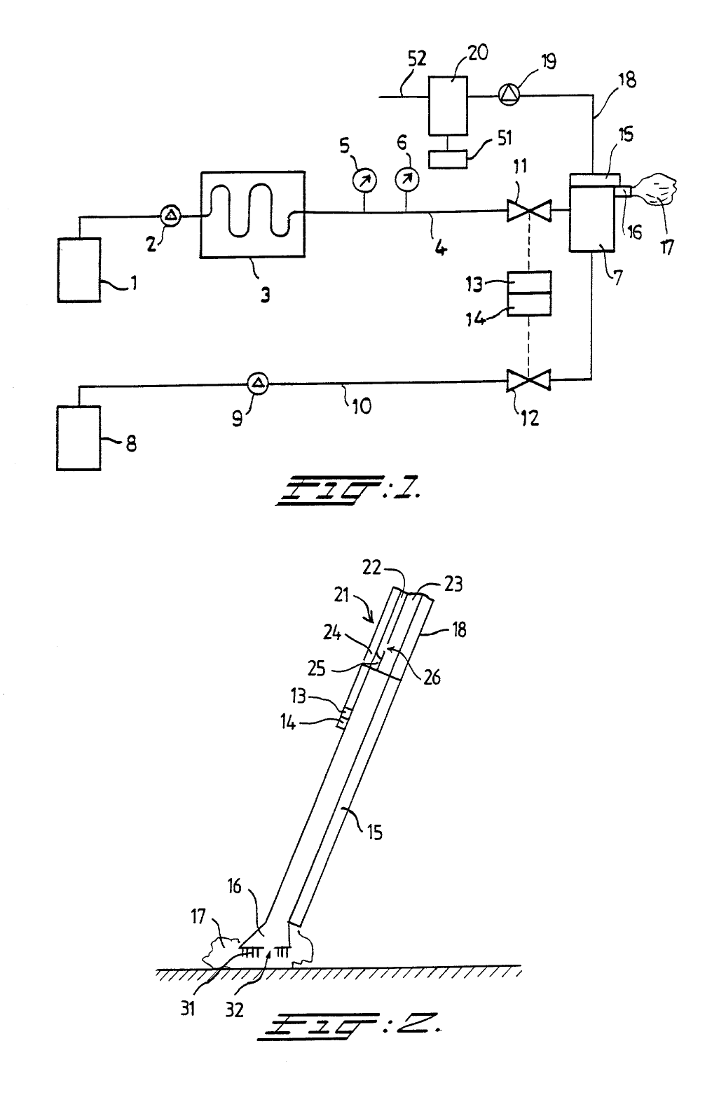

FIG. 1 shows schematically a diagram of a low-pressure steam cleaner according to the invention. A water tank 1 is connected to a water pump 2, which is in communication with a supply line of a boiler 3 for converting water into steam. The discharge line of the boiler is in communication with an application device 7 by way of a line 4 which is provided with conventional pressure meters and temperature meters 5, 6. A stock tank 8 for cleaning agent is in communication by way of pump 9 and line 10 with the line 4 near the application device 7. Valves 11 and 12 are provided in the lines 4 and 10, in order to regulate the supply of steam and cleaning agent. The valves 11 and 12 are manually operated by means of operating members 13 and 14, which are normally integral with the application device 7. The device according to the invention also comprises suction means, which comprise a suction nozzle 15 which is situated adjoining the application device 7, and the suction aperture of which is at a greater distance from the substrate to be cleaned than the spray nozzle 16 of the application device 7. The suction nozzle 15 is in communication by way of suction line 18 with a vacuum pump 19 with low flow and high vacuum, for example a flow of 50 m³ per hour at 1000 mm water column. Such pumps are commercially available, inter alia from Novavent and Nuova. The dirt and water removed are passed by way of pump 19 to separating chamber 20, where the water and dirt are separated from the air in a manner known per se. The underside of the separating chamber 20, where dirt and water collect, is in communication with a collection vessel 51. The air is discharged by way of line 52 to the environment. Collection vessel 51 and tank 1 for fresh water can be integrated in one container which has two compartments separated by a diaphragm, namely one for fresh water and one for dirty water.

FIG. 2 shows a detail of the steam cleaner according to the invention. FIG. 2 shows diagrammatically a flexible hose 21 consisting of several compartments, a compartment 22 for cleaning agent (compare line 10 in FIG. 1), a compartment 23 for steam (compare line 4 in FIG. 1), and a compartment 24 in which the connecting lines between the operating members 13 and 14 and the valves 11 and 12 are fitted. A connecting piece 25 is provided at the end of the compartment 22, shutting off said compartment. A small aperture 26 is provided in the wall between compartment 22 and compartment 23, which aperture is shut off by a one-way valve (not shown), for example a ball valve. The connecting piece 25 can also be provided with a hollow needle or tube which passes through the dividing wall 27 between compartments 22 and 23. Liquid cleaning agent that is injected by way of pump 9 into compartment 23 will expand when it emerges from aperture 26, as a result of the high pressure in the steam compartment 23, and will be converted into the gaseous state. It remains in this gaseous state until it emerges from the application device 7. Since the compartments 22 and 23 adjoin each other over a certain length, the cleaning agent will be heated up by the steam, so that the chance of the presence of liquid droplets in the steam after atomization is slight.

The application device 7 is also shown in greater detail in FIG. 2. The spray head 16 comprises at the end an outlet aperture 32 surrounded by brush hairs 31, for the exit of steam 17. As shown, the suction nozzle 15 is disposed on the rear side of the spray head 16, so that during operation the steam 17 first contacts the substrate and is then sucked off in a directed manner by way of suction nozzle 15. It will be understood that in order to ensure that steam and cleaning agent come into contact in the gaseous state with the substrate to be cleaned, the distance from the aperture 26 to the outflow aperture 32 is relatively short. However, this distance is illustrated in an exaggerated manner in FIG. 2.

In this way a device according to the invention for the removal of dirt by means of steam is provided, with which device dirt loosened by a cleaning steam can be sucked off in a directed and efficient manner by means of a vacuum pump with low flow and high vacuum. The vacuum pump with low flow and high vacuum provides directed compact removal by suction of small quantities of air at great speed. A relatively narrow, straight air column, so to speak, is sucked off, with the dirt and the steam converted to liquid in said column. The removal by suction can advantageously be directed in such a way and be kept so compact that the application of the steam and subsequent action of the steam on dirt can be carried out in a continuous process simultaneously with removal of already loosened dirt and liquid by suction. The action of the steam and the removal by suction do not interfere with each other. This permits a very efficient cleaning process.

What is claimed is:

1. Method for the removal of dirt by means of steam and a cleaning agent, which method comprises the steps of supplying cleaning agent and mixing it with the steam, and bringing the mixture into contact with the dirt to be removed, wherein the cleaning agent is injected into the steam and is brought into contact in a gaseous state with the dirt to be removed.

2. Method according to claim 1, wherein the steam and the cleaning agent are supplied separately to an application device, the injection of the cleaning agent into the steam being carried out in or near the application device.

3. Method according to claim 2, wherein the cleaning agent is preheated prior to the injection.

4. Method according to claim 3, wherein the cleaning agent is preheated by heat exchange with the steam.

5. Method according to claim 1, wherein the steam is at a pressure of less than 10 bar.

6. Method according to claim 1, wherein the temperature of the steam lies in the region of 120-160° C.

7. Method according to claim 1, wherein the dirt to be removed is pretreated with steam prior to bringing the gaseous mixture of steam and cleaning agent into contact with the dirt.

8. Method according to claim 1, wherein the treated dirt is collected by suction.

9. Method according to claim 1, in particular for the removal of chewing gum residues, wherein the cleaning agent is an aqueous solution that comprises phosphate compounds, comprising at least a combination of orthophosphate, polyphosphate and pyrophosphate, and also at least an anionic surfactant, a non-polar organic solvent and an emulsifier.

10. Method according to claim 1, wherein the ratio of steam to cleaning agent is in the region of 4-8:1, preferably approximately 6:1.

11. Device for the removal of dirt by means of steam and cleaning agent, in particular a low-pressure steam cleaner comprises a water supply container, a first pump connected to the water supply container, a steam generator for converting water into steam, having a supply line connected to the first pump and having a discharge line for the discharge of steam, a stock container for cleaning agent, which is connected to a second pump, and an application device which is in communication with the discharge line of the steam generator, and also regulating means for supplying steam or cleaning agent to the application device, wherein the discharge line of the second pump is connected to the discharge line of the steam generator by means of connecting means in such a way that during operation injection of the cleaning agent into the steam occurs and the connecting means and application device are designed in such a way that during operation a gaseous mixture of steam and cleaning agent is delivered by the application device.

12. Device according to claim 11, wherein the discharge line of the second pump is connected to one end of a line for cleaning agent, the other end of which line opens out by way of an aperture with smaller dimensions than the line for cleaning agent into a steam line, which connects the steam generator to the application device.

13. Device according to claim 12, wherein the line for cleaning agent and the steam line are in a heat-exchanging relationship with each other upstream of the abovementioned aperture.

14. Device according to claim 13, wherein the line for cleaning agent and the steam line are formed by compartments of a flexible hose containing at least two compartments, the compartment for cleaning agent preferably being provided with a one-way valve at the end.

15. Device according to claim 14, wherein connecting lines for the control of the regulating means by operating members are provided in a further compartment, which operating members are provided in a handle of the application device.

16. Device according to claim 11, wherein the application device is provided with a suction nozzle for sucking up steam and dirt that has been removed, which suction nozzle is in communication with vacuum means by way of a suction line.

17. Device according to claim 16, wherein the vacuum means comprise a vacuum pump with low flow and high vacuum.

18. Device according to claim 16, wherein the application device comprises a spray head, a suction nozzle of the suction means being disposed at one side of the spray head.

19. Device according to claim 16, wherein the end of the spray head extends beyond the end of the suction nozzle.

20. Device according to claim 16, wherein the vacuum pump is connected to a separating chamber for separating dirt and water, on the one hand, and air, on the other hand.

21. Device according to claim 16, wherein a collection container is further provided, for collection of the separated dirt and water, which container is connected to the separating chamber.
